(19) United States
(12) Patent Application Publication
(10) Pub. No.: US 2002/0196912 A1
(43) Pub. Date: Dec. 26, 2002

(54) Download and playback of audio content using short-distance wireless communication

(76) Inventor: Mariah J. Norris, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/891,907

(22) Filed: Jun. 26, 2001

(51) Int. Cl. H04M 1/64

(52) U.S. Cl. 379/88.17; 379/88.25

(57) ABSTRACT

A system and method for downloading and playback of audio content represented by digitized audio files, which are stored locally adjacent a service facility, such as a gas pump. A customer selects download of a file into remote digital storage, typically within a vehicle, through a temporary digital communication link between the local storage and the vehicle. Advantageously, the communication link can utilize BLUETOOTH™ short-distance wireless radio technology, which communicates data and voice in point-to-multipoint networks over 0-10 meter distances uses automatic frequency-hopping within the 2.4 GHz ISM band. After downloading, in response to customer input within the vehicle, a selected digitized audio file is retrieved from remote digital storage, converted into a real time audio stream, and delivered through an audio playback device. The locally stored digitized audio files are updated periodically from a larger externally networked digital storage, thereby providing new audio content.

### TECHNICAL FIELD

The present application relates to a system and method of doing business, and more particularly to an audio media downloading and playback apparatus and process.

### BACKGROUND

Currently, customers are offered discount car washes when they purchase gasoline (over $10.00 worth, for example). After sliding a credit card at pump and pumping gas, the customer has the option to also purchase carwash. It is desired to develop other services and/or merchandise that a customer can obtain while using a gas pump or other similar facility.

### SUMMARY OF THE INVENTION

The present invention is directed to a system and method for downloading and playback of audio content. The audio content is stored in digitized audio file format in a local audio store affixed adjacent a service facility, such as a gas pump. In some embodiments, the digital audio files are compressed. The audio content is typically music, education, entertainment, and/or advertising. For example, an audio content can include sample new music releases.

A customer at the service facility initiates a temporary digital communication link between the local audio store and a remote audio store movably detached from said local audio store and typically located in the customer's vehicle. In some embodiments, after sliding credit card at pump and pumping gas, the customer is offered an option to download audio content from the local audio store into his/her remote audio store, and typically to select among audio content options. In response to customer input at an interface adjacent the gas pump, at least one digitized audio file representing the selected audio content options is downloaded from the local audio store into the remote audio store over the temporary digital communication link, which can be a cable or wireless communication link.

Advantageously, the communication link utilizes BLUETOOTH™ short-distance wireless radio technology, which communicates data and voice in point-to-multipoint networks over 0-10 meter distances. It uses an automatic frequency-hopping method after one second by one-MHz intervals among the 79 hops between 2.402 GHz and 2.480 GHz in the free, unlicensed, and globally available 2.4 GHz ISM band. BLUETOOTH™ transfers data at rates of up to 721 kbps. Unlike optical and infrared communication, BLUETOOTH™ communication is not limited to line of sight. Frequency-hopping combined with wide data bandwidth makes BLUETOOTH™ a robust and advantageous short-distance communication technology.

After downloading the selected audio content in digital form, the customer terminates the temporary digital communication link between local and remote audio stores. Playback occurs, normally after the digital communication link is terminated, in response to customer input at a playback user interface interconnected with a playback processor located in a common vehicle with the remote audio store and an audio playback device, such as an audio amplifier with speaker. The playback processor retrieves a customer-selected digitized audio file from the remote audio store, converts the audio content into a real time stream of audio content, and delivers it through the audio playback device.

At selectable intervals the local audio store is updated from a central audio store networked with the local audio store with new digitized audio files representing new audio content.

In embodiments of the present invention, BLUETOOTH™ or similar technology is installed at service facilities, for example gas pumps, and in automobiles, for example at Internet radios, to send samples of new music releases to automobiles from gas pump at the option of the customer. The audio content sent can include advertising.

Embodiments of the present invention can for example help to introduce new music releases quickly, allow customer to sample new music releases, and expose customers to new lid artists and music styles. This can encourage customers to fill their tanks at particular stations (competitive advantage) or encourage a future purchase. It can also provide a new advertising channel. The discount carwash opportunity is experienced by the customer only while at the gas station/carwash. By contrast, embodiments of the present invention send music (and advertisement) with the customer after leaving the service facility, potentially stimulating the customer's awareness and interest in the music and in products advertised over an extended period of time.

### BRIEF DESCRIPTION OF THE DRAWING

FIG. 1 is a block diagram schematically illustrating the configuration of a system for download and playback of digital audio files, in accordance with an embodiment of the present invention;

FIG. 2 is a flow diagram depicting download operation, according to the present embodiment; and

FIG. 3 is a flow diagram depicting playback operation, in accordance with an embodiment of the present invention.

### DETAILED DESCRIPTION

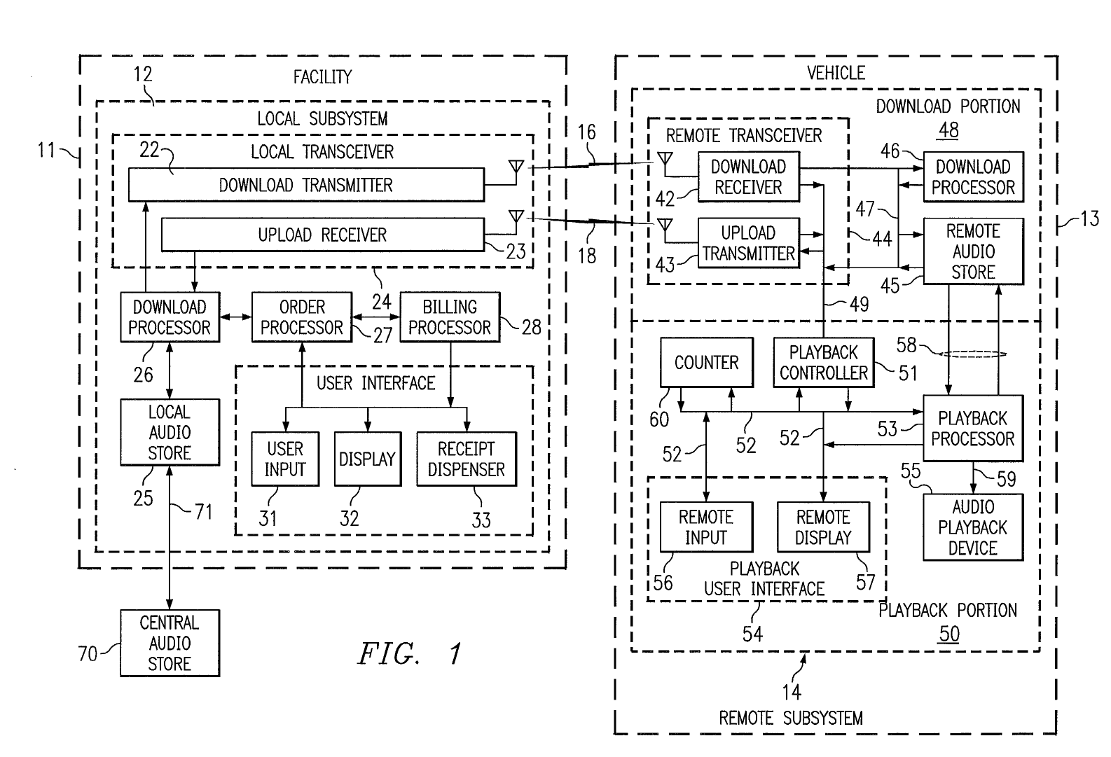

FIG. 1 is a block diagram schematically illustrating the configuration of a system 10 for download and playback of digital audio files, in accordance with an embodiment of the present invention. System 10 includes a local subsystem 12, which provides local storage, download processing, and a user selectable download control and interface for a set of digital audio files, and a remote subsystem 14, which provides remote storage, playback processing, and a user selectable playback control and interface for a downloaded set of digital audio files. Remote subsystem 14 is typically installed portably in an automobile or other movable vehicle 13, and can be connected or integrated with other audio devices commonly installed in the vehicle. Local subsystem 12 is typically installed within or adjacent to a facility 11 that provides services associated with vehicle 13. Facility 11 includes, by way of example and not by way of limitation, fuel dispensers (e.g., gas pumps), car washes, drive-through teller lanes, drive-through fast food and beverage ordering and pickup lanes, parking facilities, and parking meters.

Typically local subsystem 12 and remote subsystem 14 include means for communication between one another while in proximity with one another. Although this communication can occur over a physical link, such as an electrically conducting cable or optical fiber cable having paired connectors, the communication advantageously occurs over a short-distance wireless link 16 between a download transmitter 22 at local subsystem 12 and a download receiver 42 at remote subsystem 14, such as can be provided using BLUETOOTH™ technology (see for example International Data Corporation Bulletin, “Burgeoning Bluetooth,” March 2000).

BLUETOOTH™ is a low-cost, low-power, short-range radio technology that communicates data and voice in point-to-multipoint networks over 0-10 meters distance (up to 100 meters with an amplifier). It uses an automatic frequency-hopping method after one second by one-MHz (among the 79 hops between 2.402 GHz and 2.480 GHz) in the free, unlicensed, and globally available 2.4 GHz ISM (Industrial, Scientific, and Medical apparatus) band. BLUETOOTH™ transfers data at rates of up to 721 kbps. Unlike optical and infrared communication, BLUETOOTH™ communication is not limited to line of sight. Frequency-hopping combined with wide data bandwidth makes BLUETOOTH™ a robust and advantageous short-distance communication technology.

An optional upload wireless link 18 between an upload transmitter 43 at remote subsystem 14 and an upload receiver 23 at local subsystem 12 enables status information to be communicated from remote subsystem 14 to local subsystem 12. Alternatively, the bidirectional functionalities of download transmitter 22 and upload receiver 23 can be combined into a single local transceiver 24 at local subsystem 12, and likewise the functionalities of upload transmitter 43 and download receiver 42 can be combined into a single remote transceiver 44 at remote subsystem 14.

A local audio store 25 associated with local subsystem 12 is configured to store digital audio files in sizes, quantities, and formats as determined by an operator of system 10 from among compressed and uncompressed audio file formats known or to be known in the art. Advantageously a compressed format is used to minimize storage requirements and also to minimize download time, as discussed below in more detail. Local audio store 25 utilizes a non-volatile digital storage medium, incorporating magnetic hard disk drives, flash EPROMs or other non-volatile solid state memory, or combinations of such technologies to achieve digital storage capacities typically in the 1-4 GB range. Local audio store 25 is advantageously but need not be located physically at or adjacent local subsystem 12. Local audio store 25 can be located remotely and linked to local subsystem 12 over cable or wireless links. Alternatively, local audio store 25 can be networked together with multiple local subsystems 12, or a single local subsystem 12 can be networked to multiple local audio stores 25.

Local audio store 25 is interconnected through a download processor 26 with download transmitter 22. Download processor 26 is interconnected through an order processor 27 and a billing processor 28 with a user interface 30. Download processor 26, order processor 27, and billing processor 28 typically utilize microprocessor architectures and can optionally be combined into a single microprocessor. User interface 30 includes a user input device 31, a display 32, and an optional receipt dispenser 33. Entry device 31 can include a keypad, a magnetic card reader, and/or other conventional user input devices. Typically display 32 is a liquid crystal or LED display. Some or all of the functions of user interface 30 can be performed by existing devices installed in service facility 11, for example a keypad, credit card reader, a LED display, and a receipt dispenser resident at a gas pump.

Remote subsystem 14 includes a remote audio store 45, which is configured to store digital audio files in sizes, quantities, and formats as selected by the user at from among choices available from a manufacturer of system 10. Particularly, since remote subsystem 14 is portable in vehicle 13, remote audio store 45 will advantageously be installed integrally with or adjacent remote subsystem 14 and will store audio files in a compressed format to minimize storage requirements. Although the storage capacity of remote audio store 45 has no strict upper limit and is expected to increase as technology progresses, in practice it will typically be smaller than that of local audio store 25, since it contains a subset of the audio files of local audio store 25. Thus in near-tern embodiments, if local audio store 25 has a storage capacity of about 1-4 GB, then remote audio store 45 can be expected to have storage capacity in the 50 MB-100 MB range, utilizing non-volatile digital storage media incorporating magnetic hard disk drives, flash EPROMs or other non-volatile storage medium, or combinations of such technologies. It should be noted that using the current MP3 compressed digital audio format, one hour's worth of playback time translates into approximately 64 MB of digital storage capacity (see International Data Corporation Draft, “MP3 Players and More: Forecast and Analysis of the Worldwide Compressed Audio Player Market, 2000-2005,” January 2001).

Remote audio store 45 connects between a download portion 48 and a playback portion 50 of remote subsystem 14. In download portion 48, remote audio store 45 is interconnected, typically over a conventional digital data bus 47 with a download processor 46 and download receiver 42, which communicates over short-distance wireless link 16 with local subsystem 12. In operation, download receiver 42 receives selected download audio files from local subsystem 12, and download processor 46 processes and stores these audio files in remote audio store 45 under control from order processor 27. Download receiver 42 also receives control and query messages from order processor 27 and distributes these messages typically over a typical control bus 49. In embodiments so configured, download processor 46 monitors the status of remote audio store 45 and of communication links including short-distance wireless link 16 and digital data bus 47, and returns status messages through control bus 49, upload transmitter 43, and upload wireless link 18 to order processor 27 of local subsystem 12 in response to these control and query messages.

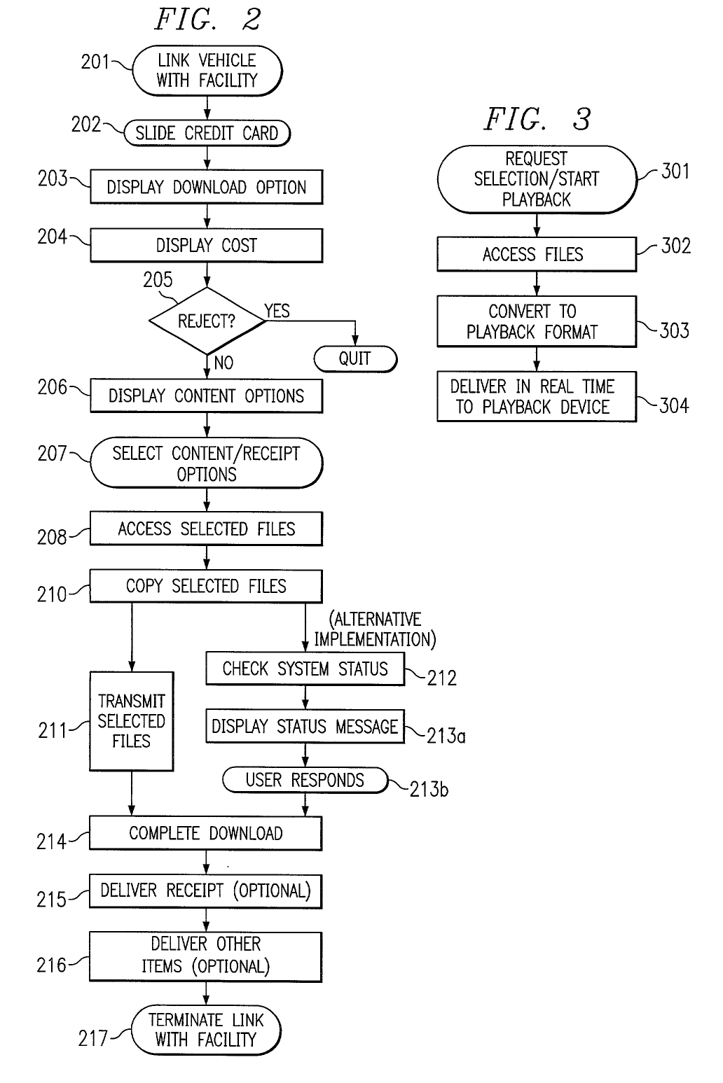

FIG. 2 is a flow diagram depicting download operation, according to the present embodiment. In this download phase, local subsystem 12 performs cooperatively with download portion 48 of remote subsystem 14 independent of playback portion 50 of remote subsystem 14. At block 201 a user moves and/or parks a vehicle 13 containing remote subsystem 14 in the proximity of a service facility 11, for example a gas station, having a local subsystem 12. In one scenario, after sliding a credit card at the gas pump in block 202, the user at block 203 receives a prompt or menu at display 32 offering the user the option of downloading audio files. At block 204 the user is advised at display 32 of the cost, if any, which will later be added to the cost of other transactions on user's credit or debit card by billing processor 28. This offer can be accepted or rejected at block 205 by the user by prompted entries at user input device 31. In some implementations, the user is allowed to choose from a display menu individual files and/or predetermined groups of files from among multiple sets of audio files. Categories can include music, news, financial, travel, entertainment, and/or other audio content. In some implementations, advertising content is included with other types of audio content. Additionally, the user can be invited at block 206 to select among other transactions and at block 207 to elect whether or not to receive a hard copy receipt or other form of record relating to any selected transactions.

If the user has elected to download audio files, then at block 208 order processor 27 instructs download processor 26 to access the user-selected file(s) in local audio store 25, copy these files at block 210, and transmit them at block 211 through download transmitter 22 over short-distance wireless link 16 into remote audio store 45 in remote subsystem 14 in vehicle 13. These download operations are accomplished using any appropriate conventional digital memory addressing and data transfer technology. If remote audio store 45 lacks available storage capacity, then the downloaded audio files are written over files already stored in remote audio store 45. Alternatively in some implementations, order processor 27 at block 212 queries the status of short-distance wireless link 16, digital data bus, and remote audio store 45, and at block 213a displays a status message to the user prior to instructing download processor 26. Examples of such messages include: “Write over current remote files? Y/N,” “Link to remote inoperable,” and the like. The user responds to these messages at block 213b. After downloading and any other selected transactions are completed at block 214, a receipt is delivered at receipt dispenser 33 at block 215 if elected by the user. Optionally, at block 216 other items such as gift certificates, discount coupons, or event tickets can be delivered at receipt dispenser 33 in connection with transactions selected by the user. Audio file downloads and other transactions at local subsystem 12 having been completed, the user can terminate the communication link between local subsystem 12 and remote subsystem 14 at block 217, for example by physically disconnecting a cable or by closing down short-distance wireless link(s) 16, 18, and can remove vehicle 13 from the proximity, e.g., 1-10 meters, of service facility 11.

Referring to FIG. 1, playback portion 50 of remote subsystem 14 includes a playback controller 51 interconnected through control bus 44 with remote audio store 45, and through control bus 52 with a playback processor 53 and a playback user interface 54. Playback user interface 54 contains a remote input device 56 configured to allow a user for example to instruct playback controller 51 to select for playback from among audio files that have been downloaded into remote audio store 45 and to start and stop playback. Playback user interface 54 also contains a remote display 57 configured to provide status information from playback controller 51 to the user. Playback processor 53 is interconnected with remote audio store 45 through a digital interface 58 and with an audio playback device 55 through an audio interface 59. Typically audio playback device 55 is a conventional automotive radio having a volume-controlled and tone-controlled amplifier and speakers and/or headphones, and commonly equipped with tape cassette or compact disc player. In some implementations, audio playback device 55 is integrated into playback user interface 54 and/or remote subsystem 14. In other implementations, audio interface 59 is through an electrically conducting connector or alternatively through an adaptor insertable into an existing cassette or compact disc receptacle. In these cases, for example, existing radio displays and controls can provide status messages (e.g., indicator lights) and remote input capability in a way that is transparent to the user. In some implementations, all or part of remote subsystem 14 is integrated with an “Internet Radio” (see International Data Corporation Draft, January 2001, cited above).

Playback operation in remote subsystem 14 typically is performed independently of and non-concurrently with the download phase described in connection with FIG. 2 above. FIG. 3 is a flow diagram depicting playback operation, in accordance with an embodiment of the present invention. At block 301 the user requests at remote input device 56 a selection from among available downloaded audio files, receives status confirmation at remote display 57, and inputs “start.” In some implementations the user is allowed to select at the individual audio file level, in other implementations the user selection is limited among predetermined groups of audio files, and in still other implementations the user has available only a single file or predetermined set of files. At block 302 the user input is applied by way of playback controller 51 to instruct playback processor 53 to access the user selected audio files stored in remote audio store 45, copy these files, convert them from compressed digital format to a format compatible with real time playback at block 303, and deliver the converted audio files serially in real time to audio playback device 55 at block 304.

Playback operation is terminated using conventional methods such as disconnecting a switch or shutting off input power. In some implementations, playback portion 50 is configured to “remember” the location in an audio file that was playing back at the termination of operation and to recall this location when playback is resumed. In some embodiments, playback operation is terminated at the end of one playback cycle of the user selected audio file(s). In other embodiments, playback of the selected audio file(s) can be cyclically repeated.

In some embodiments, audio files stored in remote audio store 45 remain available for playback until written over in a subsequent download operation. Alternatively, control messages can be embedded in an audio file to limit its playback, for example, to a predetermined maximum playback time or to a predetermined maximum total number of playback cycles. In either alternative, playback controller 51 detects and interprets the embedded message and then accordingly resets an associated counter 60 connected through control bus 52. The counter then decrements with each predetermined time unit or playback cycle, and when it reaches zero supplies a control signal to playback controller 51, which disables further playback of the particular audio file. This can be done by a number of methods, including for example deleting the particular audio file from remote audio store 45 or denying access from playback processor 53 to the memory space in remote audio store 45 occupied by the particular audio file.

Referring again to FIG. 1, in some embodiments local audio store 25 is externally updated with new audio files. Updating can be scheduled at regular time intervals, or according to predetermined criteria, or can be initiated manually. Updating is typically done from a central audio store 70 having a much greater digital storage capacity than does local audio store 25. For example, if the digital storage capacity of local audio store 25 is 1-4 GB, then the digital storage capacity of central audio store 70 can be 4-40 GB. Normally a single central audio store 70 or a redundant pair of central audio stores 70 is networked with multiple local audio stores 25 through a link 71, which can be optical fiber, electrically conductive cable, wireless, or a combination thereof. Each central audio store 70 includes digital memory, network server(s), and support apparatus (not shown in FIG. 1) conventionally associated with network servers. In one update scenario, central audio store 70 replaces all audio files in entire local audio store 25 in one update. In another update scenario, central audio store 70 updates all networked local audio stores 25 with common audio files. This can be accomplished either simultaneously by broadcasting or serially or quasi-serially through multicasting or unicasting. In another update variation, central audio store 70 replaces only partially the audio files in a given local audio store 25. In some embodiments, the audio file replacement criterion is a first-in, first-out (FIFO) aging criterion. In other embodiments, audio file replacement is applied selectively. In some implementations, local subsystem 12 includes an associated monitoring facility that tracks the frequency of download requests for each audio file, from which it adaptively derives a preference ranking according to broad and/or fine categories of audio content. This preference ranking is then communicated from local subsystem 12 to central audio store 70, which uses it to determine the audio content of a subsequent update of local audio store 25 in local subsystem 12.

In some embodiments, system 10 is configured such that the functions of user interface 30 in local subsystem 12 are performed at playback user interface 54 in remote subsystem 14. For example, user inputs associated with user input device 31 are entered at remote input device 56, and displayed prompts and confirmations at display 32 in local subsystem 12 are displayed at remote display 57 in remote subsystem 14. The user can thus select and download audio files while staying inside an automobile. It will be recognized by those having ordinary skill in the art that upgrading to this embodiment from that of FIG. 1 requires only conventional technology, for example running an extension control bus 61 linking control bus 49 with control bus 52. Likewise, it will be recognized by those having ordinary skill that numerous system configurations and architectures incorporating a range of component choices are capable of performing the functions of system 10, and these configurations, architectures, and component choices are within the scope of the present invention.

Some technical advantages of embodiments of the present invention are illustrated by the following example: Customers currently are offered discount car washes when they purchase gasoline in certain quantities (over $10.00 worth, for example). After sliding a credit card at the gas pump and after pumping gas, the customer has the option to purchase a carwash. The discount carwash opportunity is experienced by the customer only while at the gas station/carwash.

Analogously, in an embodiment of the present invention, a customer's automobile and the gas pump are equipped, for example with BLUETOOTH™ technology, such that the customer can select at the pump to download sample new music releases from a local subsystem at the gas pump into remote storage installed in the automobile. In a variation, audio advertising is also provided. The music (and advertisement) remain with the customer after they leave the station and can be played back through the customer's automobile audio system, potentially stimulating the customer's awareness and interest in the music and in products advertised over an extended period of time. Embodiments of the present invention can help publishing and recording companies to get new music releases to the public quickly, allow customer to sample new music releases, and expose customers to new artists and music styles. This can potentially encourage customers to fill their tanks at particular gas stations offering the music, thereby giving these stations a competitive advantage. Advertisers using this medium can also benefit. The opportunity to download music releases can be offered at no charge or at a discount with or without gas purchase, or can be provided for a price, all at the discretion of the gas pump owner or agent.

What is claimed is:

1. A system for download and playback of audio content, comprising:
a local audio store affixed adjacent a service facility, said local audio store operable to store at least one digitized audio file representing said audio content;
a remote audio store movably separate from said local audio store, said remote audio store operable to store said at least one digitized audio file representing audio content;
a digital communication link temporarily interconnecting said local audio store and said remote audio store, said digital communication link operable to download said at least one digitized audio file from said local audio store into said remote audio store;
an audio playback device operable to play back said audio content of said at least one digitized audio file in real time, said audio playback device being interconnected with said remote audio store through a playback processor, said playback processor operable to retrieve said at least one digitized audio file from said remote audio store and to convert said at least one digitized audio file into a real time stream of said audio content; and
a playback user interface interconnected with said playback processor and configured to capture user control input and to provide control signals to said playback processor in response to said user control input.

2. The system of claim 1 wherein said at least one digitized audio file is compressed.

3. The system of claim 1 wherein said local audio store has a digital storage capacity in the range from approximately one gigabyte to approximately four gigabytes.

4. The system of claim 1 wherein said remote audio store has a digital storage capacity in the range from approximately 50 megabytes to approximately 100 megabytes.

5. The system of claim 1 wherein said remote audio store, said audio playback device, said playback processor, and said playback user interface are located in a common vehicle.

6. The system of claim 1 wherein said service facility is a gas pump.

7. The system of claim 1 wherein said digital communication link is a wireless communication link.

8. The system of claim 7 wherein said wireless communication link has an effective working length in the range from zero meters to approximately ten meters.

9. The system of claim 7 wherein said wireless communication link is operable in a frequency range from approximately 2.402 GHz to approximately 2.480 GHz.

10. The system of claim 7 wherein said wireless communication link is configured to transfer data at rates up to 721 kilobits/second.

11. The system of claim 1 wherein said audio content is selected from the group consisting of education, music, entertainment, and advertising.

12. The system of claim 1 further comprising:
a download processor interconnected between said local audio store and said digital communication link, said download processor operable to access and download said at least one digitized audio file; and
a local user interface interconnected with said download processor and configured to capture user control input and to provide control signals to said download processor in response to said user control input.

13. The system of claim 1 further comprising a central audio store networked with said local audio store and operable to update said local audio store with at least one new digitized audio file.

14. A method of downloading and playback of audio content, comprising:
establishing a temporary digital communication link between a local audio store affixed adjacent a service facility and a remote audio store movably separate from said local audio store;
selecting audio content options;
downloading at least one digitized audio file representing said selected audio content options from said local audio store into said remote audio store over said temporary digital communication link; and
terminating said temporary digital communication link.

15. The method of claim 14 wherein said at least one digitized audio file is compressed.

16. The method of claim 14 wherein said service facility is a gas pump.

17. The method of claim 14 wherein said digital communication link is a wireless communication link.

18. The method of claim 17 wherein said wireless communication link has an effective working length in the range from zero meters to approximately ten meters.

19. The method of claim 17 wherein said wireless communication hops among frequencies separated by approximately one-MHz intervals over the frequency range from approximately 2.402 GHz to approximately 2.480 GHz.

20. The method of claim 17 wherein said at least one digitized audio file is downloaded at a transfer rate of up to 721 kilobits/second.

21. The method of claim 14 wherein said audio content options are selected from the group consisting of education, music, entertainment, and advertising.

22. The method of claim 14 further comprising:
selecting playback content;
starting playback;
retrieving said at least one digitized audio file representing said selected playback content;
converting said at least one digitized audio file into a real time stream of said audio content; and
delivering said real time stream of said audio content to an audio playback device.

23. The method of claim 22 wherein said playback device and said remote audio store are locate in a common vehicle.

24. The method of claim 22 wherein said terminating of said temporary digital communication link occurs before said selecting playback content.

25. A system for download and playback of audio content, comprising:
a local audio store affixed adjacent a service facility, said local audio store operable to store at least one digitized audio file representing said audio content;
a remote audio store movably separate from said local audio store, said remote audio store operable to store said at least one digitized audio file representing audio content;
a wireless digital communication link having an effective working length in the range from zero meters to approximately ten meters and temporarily interconnecting said local audio store and said remote audio store, said wireless digital communication link operable to download said at least one digitized audio file from said local audio store into said remote audio store; and
an audio playback apparatus operable to play back said audio content of said at least one digitized audio file in real time.

26. A method of downloading and playback of audio content, comprising:
establishing a temporary wireless digital communication link having an effective working length in the range from zero meters to approximately ten meters between a local audio store affixed adjacent a service facility and a remote audio store portably separate from said local audio store;
selecting audio content options;
downloading at least one digitized audio file representing said selected audio content options from said local audio store into said remote audio store over said temporary wireless digital communication link at a transfer rate of up to 721 kilobits/second and at frequencies hopping by approximately one-MHz intervals over the frequency range from approximately 2.402 GHz to approximately 2.480 GHz; and
terminating said temporary wireless digital communication link.

27. The method of claim 26 further comprising:
retrieving said at least one digitized audio file representing said selected playback content;
converting said at least one digitized audio file into a real time stream of said audio content; and
delivering said real time stream of said audio content to an audio playback device.

28. The method of claim 27 wherein said terminating occurs sequentially before said retrieving.

29. The method of claim 26 wherein said downloading utilizes BLUETOOTH™ short-distance wireless radio technology.
